(19) United States
(12) Patent Application Publication
(10) Pub. No.: US 2006/0282270 A1
(43) Pub. Date: Dec. 14, 2006

(54) Identity verification noise filter systems and methods

(75) Inventors: Alexander M. Sheets, Mesa, AZ (US); Kyle Kost, Phoenix, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/150,447

(22) Filed: Jun. 9, 2005

(51) Int. Cl. G06Q 99/00; G06Q 10/00

(52) U.S. Cl. 705/1

(57) ABSTRACT

The present invention provides systems and methods for reducing false positives during the process of identity verification. A host computer is configured to receive an association between a name and personal information, and an analysis is performed related to invalid, inconsistent or unusual elements of person's identity. A determination is made whether there is a heightened risk that the association is invalid in light of mitigating factors which diminish the risk. The association is designated within one of a number of certainty levels related to the risk.

### COPYRIGHT NOTICE

A portion of the disclosure of this patent document contains material, which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

Embodiments of the present invention generally relate to identity verification. More specifically, they related to providing fewer false warnings during an identity verification process.

Identity fraud is the fastest growing crime in the United States according to the FBI. Generally, identity fraud takes place when a person or persons create a fictitious identity, or manipulates and uses another person's existing identity to evade detection. Identity fraud can have many variations. For example, identity theft occurs when person or persons fraudulently take over another's identifying information. Account takeover occurs when a person or persons obtain another's personal information (account number and social security number usually suffice), and then use that information to change the mailing address with the financial institution. Once this is accomplished, there is window of opportunity to perform transactions without the victim's knowledge.

The actions listed above are directly related to the inappropriate use of identifying information. Identity fraud can be prevented to some extent through rigorous front-end screens with identity validation software or other procedures that detect inconsistencies in data provided by an individual, while simultaneously comparing this data against an aggregate of known fraudulent identities. This service can be of particular value to banks, credit unions, credit card companies, check acceptance companies, and other financial organizations.

Multiple factors can be considered, both singularly and in conjunction with other factors, to determine the level of risk that identity information is fraudulent. In some cases, the factors are normally indicative of fraud but may have certain circumstances that provide a reasonable explanation that create an exception. These exceptions are known as “noise” or “false positives.”

When a system cannot determine the circumstances that create the exception, the identity may be reported as a risk which requires that a fraud analyst perform additional research to confirm the validity of the warning. Warnings with higher false positive rates require research which is both costly and time consuming. Thus, there exists a need in the art for warning noise filters directed at the reduction of the false positive rate by defining appropriate procedures to identify the exceptions.

### BRIEF SUMMARY OF THE INVENTION

Embodiments of the present invention are directed at systems and methods for reducing false warnings during identity verification. According to different embodiments of the present invention, a host computer receives an association between a name and certain personal information. The host computer analyzes the data to determine whether there is a heightened risk of an invalid association. The association is then designated within one of a number of different certainty levels. If the association falls within specified certainty levels, the host computer then analyzes it to determine whether mitigating factors diminish the risk of an invalid association. According to different embodiments, the certainty levels are changed if the mitigating factors diminish the risk accordingly.

According to different embodiments, a host computer receives an association between a name and certain personal information. The host computer analyzes the association to determine whether mitigating factors exist which diminish the potential risk of an invalid association. The host computer then analyzes the association to determine whether there is a heightened risk of an invalid association, wherein the analysis of certain aspects of the association is eliminated because of the mitigating factors. The association is then designated within one of a number of different certainty levels related to the validity of the association.

According to different embodiments of the invention, the analysis is directed at the date that a social security number is issued, and the associated date of birth. According to different embodiments, the analysis is directed at the correlation between a name and a social security number, and the correlation if the name is inverted. According to still different embodiments, the analysis is directed at the address change history of a name or address. According to different embodiments, the analysis is directed at the correlation of a phone number and a geographic area, and whether the phone is a cell phone.

Further areas of applicability of the present invention will become apparent from the detailed description provided hereinafter. It should be understood that the detailed description and specific examples, while indicating various embodiments of the invention, are intended for purposes of illustration only and are not intended to necessarily limit the scope of the invention.

### BRIEF DESCRIPTION OF THE DRAWINGS

A further understanding of the nature and advantages of the present invention may be realized by reference to the following drawings. In the appended figures, similar components and/or features may have the same reference label.

FIG. 1 illustrates a system that may be used for identity verification according to different embodiments of the present invention.

FIG. 2 is flow diagram that illustrates a method of identity verification with a false positive filter according to different embodiments of the present invention.

FIG. 3 is flow diagram that illustrates an alternative method of identity verification with a false positive filter according to different embodiments of the present invention.

FIG. 4 is a flow diagram that illustrates the use of a name and Social Security number for alternative methods of identity verification with a false positive filter according different embodiments of the present invention.

FIG. 5 is a flow diagram that illustrates the use of a name, Social Security number and date of birth for alternative methods of identity verification with a false positive filter according different embodiments of the present invention.

FIG. 6 is a flow diagram that illustrates the use of a name, area code, prefix, and zip code for alternative methods of identity verification with a false positive filter according different embodiments of the present invention.

FIG. 7 is a flow diagram that illustrates the use of a name and address change information for alternative methods of identity verification with a false positive filter according different embodiments of the present invention.

### DETAILED DESCRIPTION OF THE INVENTION

The ensuing description provides preferred exemplary embodiments only, and is not intended to limit the scope, applicability or configuration of the invention. Rather, the ensuing description of the preferred exemplary embodiments will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

Moreover, as disclosed herein, the “storage medium” or “storage media” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor may perform the necessary tasks. Information, arguments, parameters, data, etc. may be passed, forwarded, or transmitted via any suitable means including memory sharing, message passing, token passing, network transmission, etc.

The identity verification process associated with the present invention may be initiated when a person applies for a bank account, a credit or debit card, or otherwise applies for credit. Identity verification is important to banks, credit unions, credit card companies, check acceptance companies, and other financial organizations in such circumstances. The identity verification process is important when opening other accounts, including internet accounts, or brokerage, mutual fund, and other securities accounts. Identity verification is of value in a number of other instances as well, including employment and health care. Other important points of identity verification include access to government services (e.g. social services), application for government licenses (e.g. driver or aviation license), and entrance to secure areas (e.g. airports, government offices, military bases). There are thus number of different reasons that an identity verification process may be initiated. A name and personal information is requested or otherwise provided in conjunction with applications or the provision of services to verify identity and ensure payment, among other reasons.

A name and personal information may be taken verbally, whether it be in person or over the phone. The name and personal information may also be provided electronically, through the Internet, phone, cable, or other medium. Many other examples are possible and apparent to those skilled in the art in light of this disclosure. According to different embodiments, the personal information may include an address, a driver's license number, a phone number, a fax number, an email address, a social security number, a date of birth; a bank account number, a credit card number, or a PIN. The personal information may include a portion of at least one of the foregoing pieces of information. The personal information may also include a variety of combinations of the foregoing pieces of information. The name and associated personal information will then be and analyzed to determine whether the association is invalid, as described below.

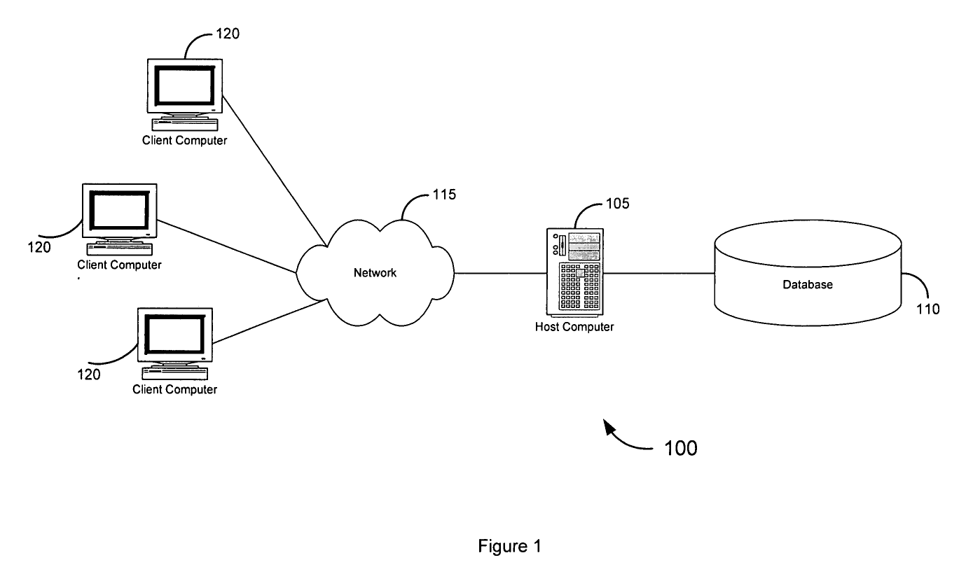

The name and the personal information associated with the name is sent to the host computer. A basic configuration 100 is depicted in FIG. 1 for purposes of explaining the systems and methods of the present invention. The host computer 105 may include, for example, server computers, personal computers, workstations, web servers, or other suitable computing devices. The host computer 105 includes application software that programs the host computer 105 to perform one or more functions according to the present invention. For example, application software resident on the host computer 105 may program the host computer 105 to receive and analyze the name and personal information. The host computer 105 may include one or more of the aforementioned computing devices, as well any number of storage media. The host computer 105 may be fully located within a single facility or distributed geographically, in which case a network may be used to integrate the host computer 105. Many other examples are possible and apparent to those skilled in the art in light of this disclosure.

The host computer 105 is associated with at least one database 110. According to different embodiments of the invention, the database 110 contains information related to names, personal information, and potentially invalid associations between names and personal information. The database 110 may include information on the following parameters: (a) known high-risk identities, (b) account takeover screening parameters, (c) address change history, (d) known or suspected suspicious addresses, (e) demographic information, (f) archived historical account opening information, (g) Social Security number and name tables, (h) Social Security number issue dates, (i) phone numbers issued to cell phones, and (j) additional address histories. The database 110 may also contain other data and comparison tables related to identity verification, examples of which are apparent to those skilled in the art in light of this disclosure. The database 110 may be a part of the host computer 105 within its storage media, or may be a part of a separate system associated with the host computer 105.

According to some embodiments, the invention also includes a communications network (“network”) 115, which may be the Internet, an intranet, a wide-area network (“WAN”), a local-area network (“LAN”), a virtual private network, or the like, in different embodiments. The network 115 may include both wired and wireless connections, including optical links. Through the network 115, at least one client computer 120 communicates with the host computer 105.

A client computer 120 may be any device capable of interacting with the host computer 105 through a communications link, such as the network 115. For example, a client computer 120 may be a personal computer, workstation, server, or the like. A client computer 120 may access web pages at the host computer 105 through the network. Such web pages may allow users at the client computer 120 to view information or provide information related to identity verification.

The systems and methods associated with the present invention may be made available in a variety of forms. By way of example, embodiments of the invention may be in the form of licensed software for identity verification, wherein a customer runs the software on their own, proprietary host computer 105 systems. In such a case, a client computer 120 owned by a customer may send the name and personal information over a LAN 115 to the host computer 105. Alternatively, embodiments of the invention may be implemented through an application service provider (ASP) model, wherein the information may be transmitted by a client computer 120 over a WAN 115 to a service provider where the analysis takes place on a host computer 105 not owned or managed by the customer.

The identity verification analysis can take place at different time intervals, as well. By way of example, “batch” identity verification is based on an extract of specified associations for a given period of time (typically once per day) into a batch of records that is processed sequentially through the system generating a report of all identities that have a specified risk of being fraudulent. Longer or shorter intervals may be used as well. “Real-time” identity verification is based on a single new account record processed through the system generating an on-line response moments later showing any elements of the identity that indicate a risk that the identity is fraudulent.

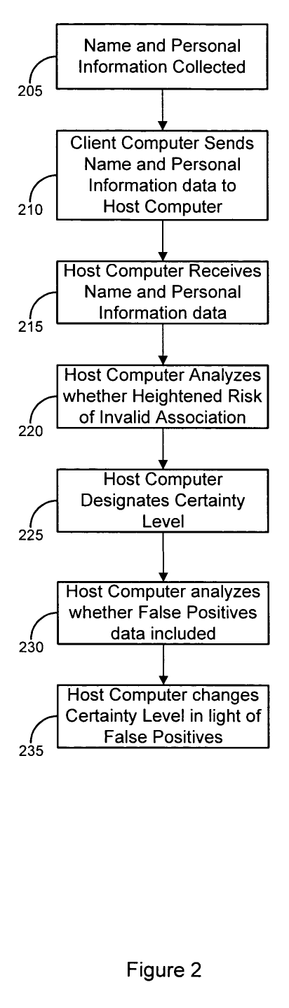

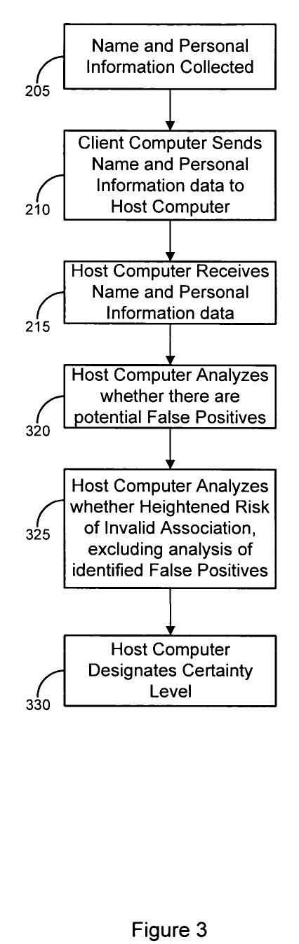

FIGS. 2 and 3 provide flow diagrams that illustrate various aspects of the false positive filter used in different embodiments of the invention. As noted above, a name and associated personal information are collected 205. A next step 210, comprises the client computer 120 sending data correlated to the name and associated personal information to the host computer 105 over the network 115. A next step 215, comprises the host computer 105 receiving the data. FIG. 2 illustrates the flow diagram for some embodiments of the invention; wherein the host computer 105 analyzes the data to determine 220 whether there is a heightened risk of an invalid association.

With the systems and methods of the present invention, multiple factors may considered, both singularly and in conjunction with other factors, to determine 220 whether there is a heightened risk of an invalid association, and the level of risk that identity information is fraudulent. Utilizing a variety of analytics and a set of data tables, some of which are known in the art, invalid, inconsistent or unusual elements of person's identity are sought. These parameters may include (a) known high-risk identities, (b) account takeover screening, (c) address changes comparison to suspicious addresses, (d) demographic changes, (e) specific event indicators, and (f) inconsistencies between archived historical account opening data and new applicant information. Thus, according to different embodiments of the invention, the host computer 105 analyzes the data correlated to the name and associated personal information to determine 220 whether there is a heightened risk of an invalid association.

According to different embodiments, the identity at issue is designated 225 within one of a number of certainty levels. These certainty levels may signify different ranges of probabilities that a given identity is invalid or fraudulent. By way of example, the levels may be numbers, letters, colors, logos, icons or any other identifying feature. The levels may be associated with certain actions to be undertaken. According to different embodiments, there must be at least one warning level which requires additional research into whether the association is valid.

In some cases, the factors that are normally indicative of fraud or invalidity are benign. These exceptional circumstances are known in the art as “noise” or “false positives.” Some warnings with high false positive rates require additional research that is both costly and time consuming. The present invention employs warning noise filters that reduce the false positive rate by defining the circumstances that are exceptions. According to different embodiments of the present invention, the host computer 105 analyzes 230 whether false positive data has been included in the initial analysis 220 of the heightened risk. These false positives constitute mitigating factors that may diminish the heightened risk. According to some embodiments, the host computer 105 changes the certainty level 235 if such mitigating factors are present.

FIG. 3 illustrates the flow diagram for alternative embodiments of the invention; wherein the host computer 105 analyzes 320 whether there are potential false positives present that may improperly indicate a heightened risk of an invalid association. The false positives constitute mitigating factors that may diminish the potential risk of an invalid association. The host computer 105 then analyzes 325 whether there is a heightened risk of an invalid association, wherein the analysis of issues corresponding to the existing mitigating factors is eliminated. The host computer 105 designates 330 the identity at issue within one of a number of certainty levels.

The identification of “false positives” or “noise” is factored into the analysis regarding a potential heightened risk of an invalid association between a name and personal information, as described above. Properly identified “false positives” or “noise” constitute mitigating factors that diminish the otherwise heightened risk correlated to an association between a name and personal information. The above descriptions are mere examples of how such mitigating factors can be considered in the analysis of the risk. Those skilled in the art will recognize that there are a number of additional alternative ways that such information may be considered, and the specifics provided do not limit such alternatives. The following examples are illustrative of the analysis regarding false positives.

I. Name—Social Security Number Correlation: According to different embodiments of the present invention, the name and associated Social Security number (“SSN”) used for identity verification are analyzed to determine if the name is properly associated with the SSN. Because the Social Security Administration does not provide access to their SSN/name information, 3^{rd} party tables, compiled from SSN/name usage, may be used for the verification process. The information in the 3^{rd} party tables is often based on manually entered data. In some cases, this data may inadvertently be entered in the wrong sequence (i.e. last name first, first name last). The name data submitted for identity verification is also manually entered and may have the same inversion issues. This is more likely in the case of certain foreign names that are unfamiliar.

If the name in the verification table associated with a SSN is not the same as the name submitted for verification with the SSN, there typically is a heightened risk of an invalid identity. A warning regarding a SSN and name inconsistency may necessitate contact with the customer to confirm the data supplied or require additional research with other 3^{rd} party sources.

A procedure wherein a submitted name is inverted (last to first, first to last), and the name comparison repeated with the verification tables, may effectively reduce the amount of warnings and research required. Many SSN/Inverted Name verifications result in a match, and thus require less action. The same tables may be used for both the standard SSN/name verification and the SSN/inverted name verification. According to some embodiments, the standard verification is performed first, followed by the inverted name verification for the cases that do not match the verification table. According to other embodiments, both the name and inverted name verification are performed before any heightened risk is assessed.

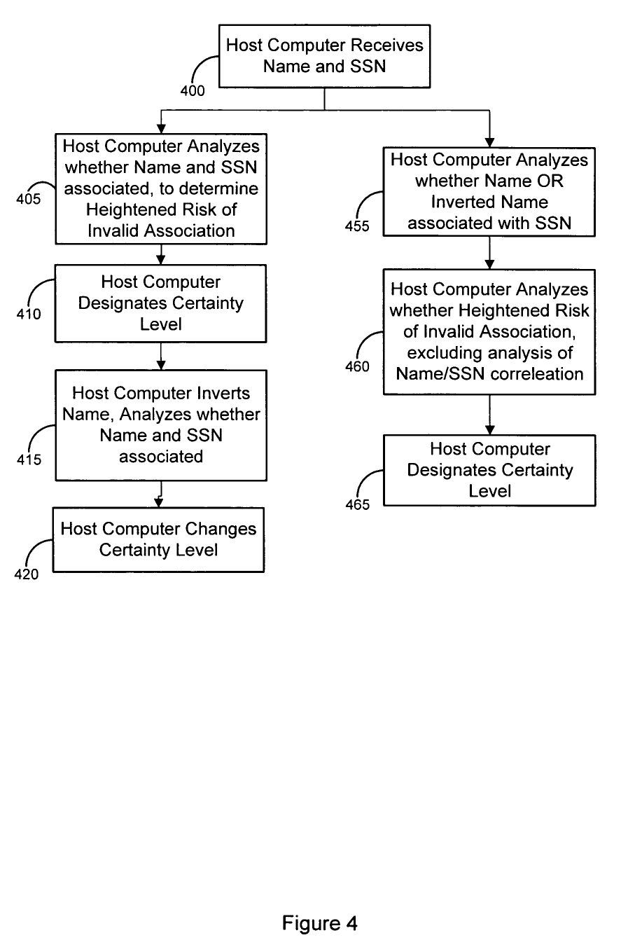

FIG. 4 illustrates these alternative embodiments of the invention. Under both alternatives, the process is initiated when the host computer 105 receives a name and personal information 400, which in this case comprises a SSN. According to some embodiments, the host computer 105 analyzes whether a name and SSN are associated 405, to determine whether there is a heightened risk of invalid association. The host computer 105 designates a certainty level 410. If there is no association, the host computer 105 inverts the name and analyzes 415 whether the inverted name and SSN are associated. If so, the host computer may change 420 the certainty level accordingly. According to alternative embodiments, the host computer 105 analyzes whether the name OR inverted name are associated with the SSN 455. If so, the host computer analyzes 460 whether there is a heightened risk of invalid association excluding the association between the name and SSN. The host computer then designates a certainty level 465.

II. SSN Recently Issued—Infant: The Social Security Administration provides a table of issue dates for ranges of SSN values. A recently issued SSN may be indicative of an attempt to create a new identity. According to different embodiments of the invention, the issue date of the SSN provided for identity verification is used to determine if there is a heightened risk of an invalid association between a name and personal information.

Most SSNs are applied for very soon after birth, often even before leaving the hospital. New financial accounts are also often opened at this time for infants. A recently issued SSN for an infant is not a cause for a heightened risk. According to different embodiments of the present invention, this “Recently Issued SSN” comparison for account holders under a certain age may be bypassed. The age range can be varied, and different levels of risk can be associated with different ages. Age and SSN issue date ranges are parameters which may set by a user.

According to some embodiments, the “Recently Issued SSN” comparison is performed first, followed by a check of the date of birth. According to other embodiments, the date of birth is analyzed first, and the association for persons below a specified age are not analyzed under the “Recently Issued SSN” comparison. The specific variables of date of birth, time since SSN issue, and level of heightened risk based on these factors can be varied according to different embodiments of the invention.

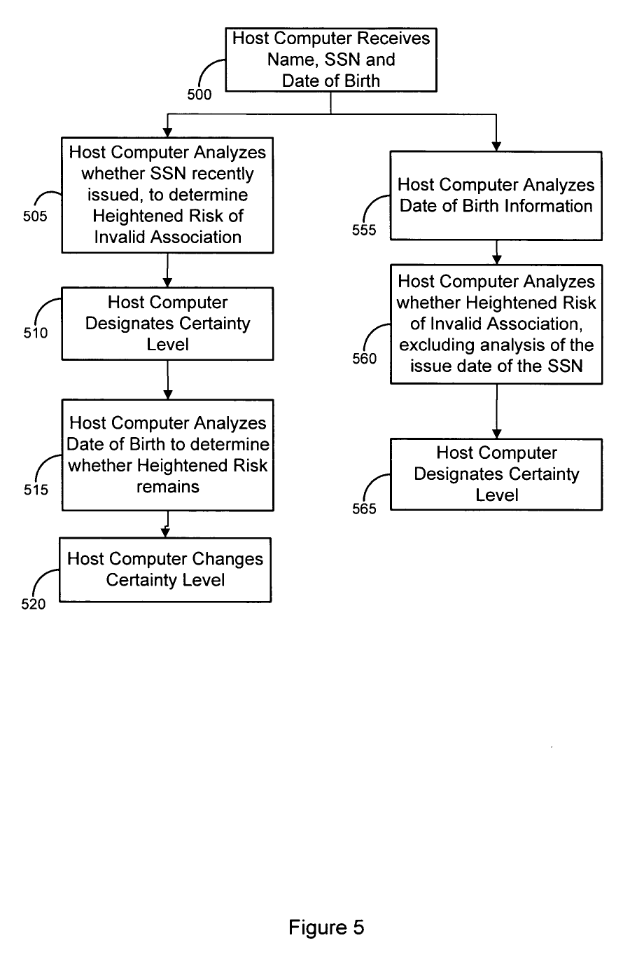

FIG. 5 illustrates alternative embodiments of the invention. Under both alternatives, the process is initiated when the host computer 105 receives a name and personal information 500, which in this case comprises a SSN and date of birth. According to some embodiments, the host computer 105 analyzes whether the SSN was recently issued 505, to determine whether there is a heightened risk of invalid association. The host computer 105 designates a certainty level 510. If the SSN is deemed a recent issue, the host computer 105 analyzes the date of birth 515 to determine whether the heightened risk remains. If not, the host computer may change 520 the certainty level accordingly. According to alternative embodiments, the host computer 105 analyzes the date of birth information 555. Depending on the analysis, the host computer 105 limits or excludes 560 analysis of the issue date of the SSN. The host computer then designates a certainty level 565.

III. Area Code/Prefix/Zip Code—Cell Phone: The area code and prefix of a phone number may be compared to a 5 digit zip code to determine if the area code and prefix are used in that zip code. Other address information can similarly be tied to phone numbers, but for purposes of this example, the zip code will be used. There are different sources of valid area code/prefix/zip code combinations. For example, one is a commercially available source that provides the three most common combinations for each zip code in the United States. A second source is compiled as combinations are evaluated—once a specified number of occurrences of a combination have been processed, that combination is stored and considered valid for future comparisons.

The utility of the comparison is based on phone numbers being assigned to specific geographic areas. This concept is very accurate for physical phone lines. Cell phone numbers are not necessarily assigned by geographic area, and therefore the comparison may not provide consistent results.

Use of a cell phone as a primary phone number is now a common practice. This creates the potential for many warnings that are not indicative of fraud, and also may pollute the table with invalid combinations. Commercially available sources provide phone number ranges that are assigned to cell phone companies. According to different embodiments of the invention, false positives can be diminished with a first comparison of the phone number to the cell phone number table. The generalized comparison can then be bypassed if the phone number is in a cell phone range. According to other embodiments, the valid area code, prefix and zip code comparison is performed first, and the cell phone number table is used only for those cases in which there is no geographic match.

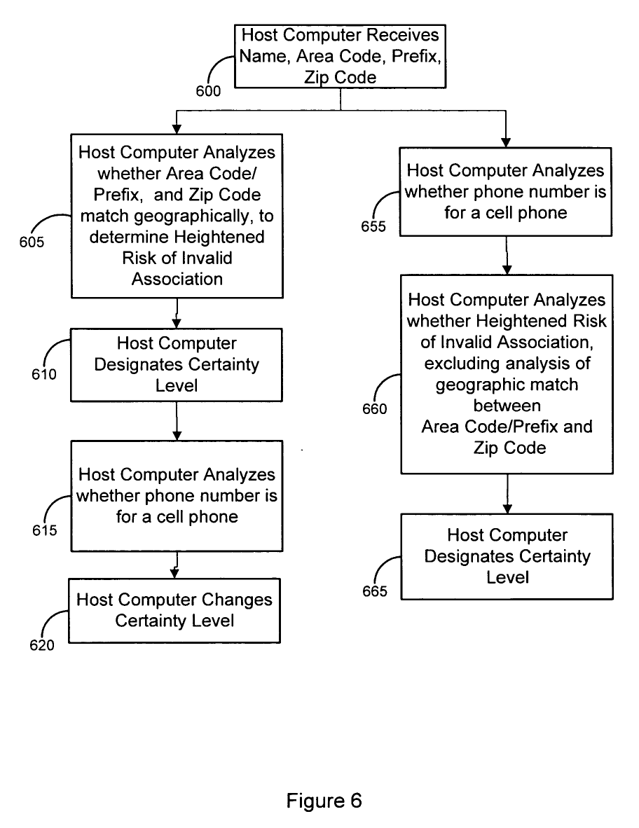

FIG. 6 illustrates alternative embodiments of the invention. Under both alternatives, the process is initiated when the host computer 105 receives a name and personal information 600, which in this case comprises an area code, prefix, and zip code. According to some embodiments, the host computer 105 analyzes whether the area code and prefix are matched to the zip code geographically 605, to determine whether there is a heightened risk of invalid association. The host computer 105 designates a certainty level 610. If there is no match, the host computer 105 analyzes whether the phone number is for a cell phone 615. If so, the host computer may change 620 the certainty level accordingly. According to alternative embodiments, the host computer 655 analyzes whether the phone number is for a cell phone. If so, the host computer analyzes whether there is a heightened risk of invalid association while limiting or excluding 660 analysis of the geographic match between the area code and prefix and the phone number. The host computer then designates a certainty level 665.

IV. Address Change: Fraud rings often steal the identities of multiple consumers with the intent to take over their identity to steal funds from accounts, use the consumer's credit, or use a consumer's account to pass fraudulent checks. A fraud ring may change the address of accounts for the consumer so that notices, statements, and other contact information will not be sent to the consumer address, thus notifying the consumer that something is amiss with their account. The fraud ring often uses a single address for different consumer's accounts to simplify their efforts.

According to different embodiments of the present invention, an analysis is performed to check address changes to determine if a new address is a mail drop, e.g. a non-permanent address like a rented mail box, or other address related “red flags”. A history of address changes may be maintained so that a warning can be provided if a single account has multiple address changes over a period of time. Additionally, there may be a comparison between the new address of an account and new addresses for other unrelated accounts. If multiple, unrelated accounts are being changed to the same new address, there may be a heightened risk indicating that a fraud ring may be attempting to steal identities and take over the accounts.

If the multiple accounts are for different consumers with the same last name, the accounts at issue may be for family members, and an exception may be created. If multiple signers on the same account have a change to the same new address, that may also be considered an exception. Similar exceptions may be created if the multiple accounts all had the same previous address. Those skilled in the art will recognize the different combinations possible, and that different risk and mitigation weight that may be applied in light of different circumstances.

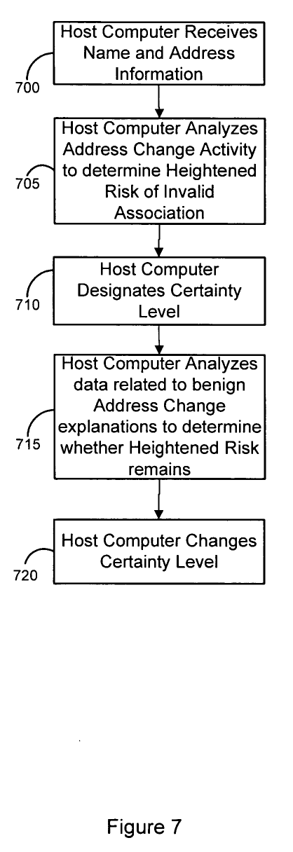

FIG. 7 illustrates embodiments of the invention, wherein the process is initiated when the host computer 105 receives a name and personal information 700, which in this case comprises address information. The host computer 105 analyzes address change activity 705 as described above to determine whether there is a heightened risk of invalid association. The host computer 105 designates a certainty level 710. If there is an issue, the host computer 105 analyzes whether there are benign explanations 715 related to the address change that diminish the heightened risk of invalid association. If so, the host computer 105 may change the certainty level accordingly 720.

It should again be noted that the methods, systems and devices discussed above are intended merely to be exemplary in nature. Consequently, various embodiments may omit, substitute and/or add various procedures and/or components as appropriate. For instance, it should be appreciated that in alternative embodiments, the methods may be performed in an order different than that described.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for reducing false warnings during identity verification, comprising:
providing a host computer, including at least one associated database;
receiving, at the host computer, data correlated to an association between a name and personal information;
analyzing the data correlated to the association with the host computer to determine whether there is a heightened risk of an invalid association;
designating the association within one of a plurality of certainty levels related to the risk of an invalid association; and
analyzing the data correlated to the association with the host computer, if the association falls within specified certainty levels, to determine whether mitigating factors diminish the risk of an invalid association.

2. The method of claim 1, further comprising the step of:
changing the certainty level designation if the mitigating factors diminish the risk accordingly.

3. The method of claim 1, wherein an invalid association is a fraudulent association.

4. The method of claim 1, wherein the personal information is selected from the group consisting of: an address, a driver's license number, a phone number, a fax number, an email address, a social security number, a date of birth; a bank account number, a credit card number, a PIN, a portion of at least one of the foregoing pieces of information, and combinations of the foregoing pieces of information.

5. The method of claim 1, wherein the certainty levels comprise numbers corresponding to different probabilities that the association between the name and the personal information is invalid.

6. The method of claim 1, wherein the certainty levels include at least one warning level which requires additional research into whether the association is invalid.

7. A computer-readable medium having computer-executable instructions for performing the computer-implementable method for reducing false warnings during identity checks of claim 1.

8. The method of claim 1, wherein,
the receiving step comprises receiving data correlated to an association between a name and a social security number;
the first analyzing step comprises the determination of whether a heightened risk of an invalid association exists because the name does not correlate to the social security number; and
the second analyzing step comprises the determination of whether the risk is diminished if the name is inverted.

9. The method of claim 1, wherein,
the receiving step comprises receiving data correlated to an association between a name and a date of birth and social security number;
the first analyzing step comprises the determination of whether a heightened risk of an invalid association exists because of the date that the social security number was issued; and
the second analyzing step comprises the determination of whether the risk is diminished because of the date of birth.

10. The method of claim 1, wherein,
the receiving step comprises receiving data correlated to an association between a name and an address and phone number;
the first analyzing step comprises the determination of whether a heightened risk of an invalid association exists because the phone number is not assigned to the geographic area associated with the address; and
the second analyzing step comprises the determination of whether the risk is diminished because the phone number is related to a cell phone.

11. The method of claim 1, wherein,
the receiving step comprises receiving data correlated to an association between a name and an address;
the first analyzing step comprises the determination of whether a heightened risk of an invalid association exists because of the address change history of the name or address; and
the second analyzing step comprises the determination of whether the risk is diminished because the address change relates to different people with the same last name, same account number, or same previous address.

12. A method for reducing false warnings during identity verification, comprising:
providing a host computer, including at least one associated database;
receiving, at the host computer, data correlated to an association between a name and personal information;
analyzing the data correlated to the association with the host computer to determine whether mitigating factors exist which diminish the potential risk of an invalid association;
analyzing the data correlated to the association with the host computer to determine whether there is a heightened risk of an invalid association, wherein the analysis of issues corresponding to the existing mitigating factors is eliminated; and
designating the association within one of a plurality of certainty levels related to the risk of an inaccurate association.

13. The method of claim 12, wherein an invalid association is a fraudulent association.

14. The method of claim 12, wherein the personal information is selected from the group consisting of: an address, a driver's license number, a phone number, a fax number, an email address, a social security number, a date of birth; a bank account number, a credit card number, a PIN, a portion of at least one of the foregoing pieces of information, and combinations of the foregoing pieces of information.

15. The method of claim 12, wherein the certainty levels comprise numbers corresponding to different probabilities that the association between the name and the personal information is invalid.

16. The method of claim 12, wherein the certainty levels include at least one warning level which requires additional research into whether the association is invalid.

17. The method of claim 12, wherein,
the receiving step comprises receiving data correlated to an association between a name and a date of birth and social security number;
the first analyzing step comprises the determination of whether the date of birth constitutes a mitigating factor which diminishes the potential risk related to the date that the social security number was issued; and
the second analyzing step comprises the determination of whether there is a heightened risk of an invalid association, wherein the analysis related to the date of issue of the social security number is eliminated.

18. The method of claim 12, wherein,
the receiving step comprises receiving data correlated to an association between a name and an address and phone number;
the first analyzing step comprises the determination of whether the phone number is assigned to a cell phone and thus constitutes a mitigating factor which diminishes the potential risk related to the geographic correlation of the address and phone number; and
the second analyzing step comprises the determination of whether there is a heightened risk of an invalid association, wherein the analysis related to the geographic correlation of the address and phone number is eliminated.

19. A system to reduce false warnings during identity checks, comprising
a host computer; and
at least one database associated with the host computer, the database having information related to names, personal information, and potentially invalid associations between names and personal information;
wherein the host computer is configured to receive an association between a name and personal information and to determine whether there is a heightened risk that the association is invalid in light of mitigating factors which diminish the risk, and to designate the association within one of a plurality of certainty levels related to the risk.

20. The system of claim 19, wherein an invalid association is a fraudulent association.

21. The system of claim 19, wherein the personal information is selected from the group consisting of: an address, a driver's license number, a phone number, a fax number, an email address, a social security number, a date of birth; a bank account number, a credit card number, a PIN, a portion of at least one of the foregoing pieces of information, and combinations of the foregoing pieces of information.

22. The system of claim 19, wherein the certainty levels comprise numbers corresponding to different probabilities that the association between the name and the personal information is invalid.

23. The system of claim 19, wherein the certainty levels include at least one warning level which requires additional research into whether the association is invalid.

24. The system of claim 19, wherein,
the personal information comprises a name and a Social Security number; and
the host computer determines whether there is a heightened risk that the association is invalid because the name does not correlate the Social Security number, in light of whether there is a correlation if the name is inverted.

25. The system of claim 19, wherein,
the personal information comprises a date of birth and Social Security number; and
the host computer determines whether there is a heightened risk that the association is invalid because of the date that the Social Security number was issued, in light of the date of birth.

26. The method of claim 19, wherein,
the personal information comprises an address and phone number;
the host computer determines whether there is a heightened risk that the association is invalid because the phone number is not assigned to the geographic area associated with the address, in light of whether phone number is related to a cell phone.

27. The system of claim 19, wherein,
the personal information comprises an address;
the host computer determines whether there is a heightened risk that the association is invalid because of the address change history of the name or address, in light of whether the address changes relate to different people with the same last name, same account number, or same previous address.
